(19) United States
(12) Patent Application Publication
(10) Pub. No.: US 2012/0234984 A1
(43) Pub. Date: Sep. 20, 2012

(54) Integrated Duct Design for an Unmanned Aerial Vehicle

(75) Inventors: Adam Entsminger, Blacksburg, VA (US); Daniel Ross Collette, Albuquerque, NM (US)

(73) Assignee: HONEYWELL INTERNATIONAL INC., Morristown, NJ (US)

(21) Appl. No.: 12/187,112

(22) Filed: Aug. 6, 2008

(51) Int. Cl. B64C 29/02

(52) U.S. Cl. 244/23 A

(57) ABSTRACT

A ducted fan air vehicle having increased storage capacity inside the duct for equipment and electronics provides improved airflow and fan efficiency over ducted fan air vehicles carrying cargo in external pods. The outside of the duct may extend outwardly to allow equipment and electronics to be stored inside the duct in storage areas located at intervals along the duct. The storage areas may form a square duct having a circular inside wall. Additionally, the storage areas may extend in the direction of the axis of rotation of the fan to provide additional storage above the lower lip of the duct.

### GOVERNMENT RIGHTS

The United States Government may have rights in the invention under the contract W56HZV-05-C-0724 with the United States Army.

### FIELD

The present invention relates generally to an integrated duct design for a ducted fan vehicle. More specifically, the invention relates to an unmanned aerial vehicle (UAV) having a duct capable of storing electronics and equipment inside the duct.

### BACKGROUND

Unmanned aerial vehicles may have at least one ducted fan and a fan engine to drive the fan blades. The ducted fan produces an airstream that may enable the UAV to hover or move translationally parallel to the ground.

UAV vehicles may be used to transport equipment, perform surveillance, obtain information from sensors, place sensors or other payload in a dangerous or inaccessible area, or to perform contaminant testing. In order to reach the target destination, and to perform the desired task, UAVs may need to store equipment such as avionics, controls, payload, and sensing equipment.

Some UAVs may store such equipment in external pods attached to the duct. These pods may cause a shift in the center of gravity, may create negative interference with airflow characteristics inside the duct by blocking air intake and exhaust, and may create additional drag on the UAV when the UAV is in forward flight. Additionally, the added weight of the equipment may require additional engine capacity and fuel storage capacity. The additional engine capacity and additional fuel that must be carried further add to the weight, and may therefore decrease the fuel efficiency of the vehicle.

Alternatively, some UAVs may store equipment inside the duct. UAVs may typically have a circular duct. Storing equipment inside the duct may require that the thickness and the diameter of the circular duct be increased. Increasing the diameter and the thickness of the circular duct may affect a large number of design criteria for the UAV, such as the center of gravity, engine size, thrust power, fuel requirements, weight, controls, as well as other possible effects.

Therefore, there is a need for an improved means of storing equipment on a ducted fan aerial vehicle.

### SUMMARY

The present disclosure describes a ducted-fan unmanned air vehicle (UAV) having space inside the duct for carrying equipment or cargo. UAVs may carry equipment on board, such as avionics equipment, control equipment, sensors, and fuel. Traditionally, equipment carried by the UAV may be stored in removable or fixed storage pods attached to the duct of the UAV. These storage pods may create interference with airflow and may cause losses in overall efficiency due to the disturbance of the airflow around the UAV. One approach to providing increased area for storing equipment and payload on the UAV was to create a duct having space inside it. If additional storage was necessary, the size of the outer diameter of the circular duct may could be expanded.

An improved system and method for storing equipment on the UAV creates additional space between the inner and outer wall of the duct at specified intervals along the circumference of the duct. This may create “corners” on the duct having increased storage capacity. Using these corners on the duct of the UAV may result in improved fuel efficiency and thrust of the UAV fan over other systems in which pods are attached to the circumference of the duct of the UAV, or in systems in which the outer diameter of the duct was increased to accommodate additional equipment inside the duct.

Further, the area on the duct used to store equipment may be further increased by raising the corners of the duct in a direction substantially parallel to the axis of rotation of the fan.

Creating space inside the duct in corners located on the perimeter of the duct of the UAV and raising the corners of the duct in a direction parallel to the axis of rotation of the fan may result in increased efficiency, decreased turbulence, and improved thrust over systems having equivalent cargo capacity in which the duct outer perimeter is circular or in which storage pods are attached to the perimeter of the duct of the UAV.

Other objects, advantages and novel features, and further scope of applicability of the present disclosure will be set forth in part in the detailed description to follow, taken in conjunction with the accompanying drawings, and in part will become apparent to those skilled in the art upon examination of the following, or may be learned by practice of the disclosure. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1a is a pictorial representation of a top view of a ducted fan UAV having a substantially square outer duct, according to an example.

FIG. 1b is a pictorial representation of a perspective view of a ducted fan UAV having a substantially square perimeter, according to an example.

FIG. 1c is a pictorial representation of a side view of a ducted fan UAV having a substantially square perimeter, according to an example.

FIG. 1d is a pictorial representation of a side view of a ducted fan UAV having a substantially square perimeter and rotated 45° around the axis of rotation from the view of FIG. 1c, according to an example.

FIG. 1e is a graph of two cross-sections of the duct of the UAV having a substantially square perimeter, according to an example.

FIG. 2a is a pictorial representation of a top view of a ducted fan UAV having a substantially square perimeter and raised corners, according to an example.

FIG. 2b is a pictorial representation of a perspective view of a ducted fan UAV having a substantially square perimeter and raised corners, according to an example.

FIG. 2c is a pictorial representation of a side view of a ducted fan UAV having a substantially square perimeter and raised corners, according to an example.

FIG. 2d is a pictorial representation of a side view of a ducted fan UAV having a substantially square perimeter and raised corners, and rotated 45° around the axis of rotation from the view of FIG. 1c, according to an example.

FIG. 2e is a graph of two cross-sections of the duct of the UAV having a substantially square perimeter and raised corners, according to an example.

### DETAILED DESCRIPTION

Ducted-fan UAVs are known for their superior stationary aerodynamic hovering performance, three-dimensional precision position hold, low speed flights, precision vertical take-off and landing (“VTOL”) and safe close-range operations. Ducted fan air-vehicles may be preprogrammed to perform operations autonomously, or they may be controlled by a human operator. Therefore, ducted fan air-vehicles may be unmanned aerial vehicles.

UAVs may have avionics equipment on board to control the flight and operation of the UAV. For instance, the avionics may control the direction, flight, stability compensation, and other aspects of flight control. Additionally, UAVs may carry a variety of equipment on board tailored to the mission the UAVs are assigned to accomplish. UAVs may carry sensors on board to obtain information about surroundings, or the UAVs may carry a payload to be deposited at a target site. The UAV engine to drive the UAV requires that fuel be carried on board the UAV. The avionics equipment, sensors, payload, and fuel may be stored on the UAV.

The present invention describes a system and a method of creating increased storage on the UAV for a given inner diameter of the duct of the UAV. The duct of the UAV is shaped to provide additional storage between the inside and outside walls of the duct by creating a larger area between the inside and outside wall of the duct at intervals along the circumference of the duct.

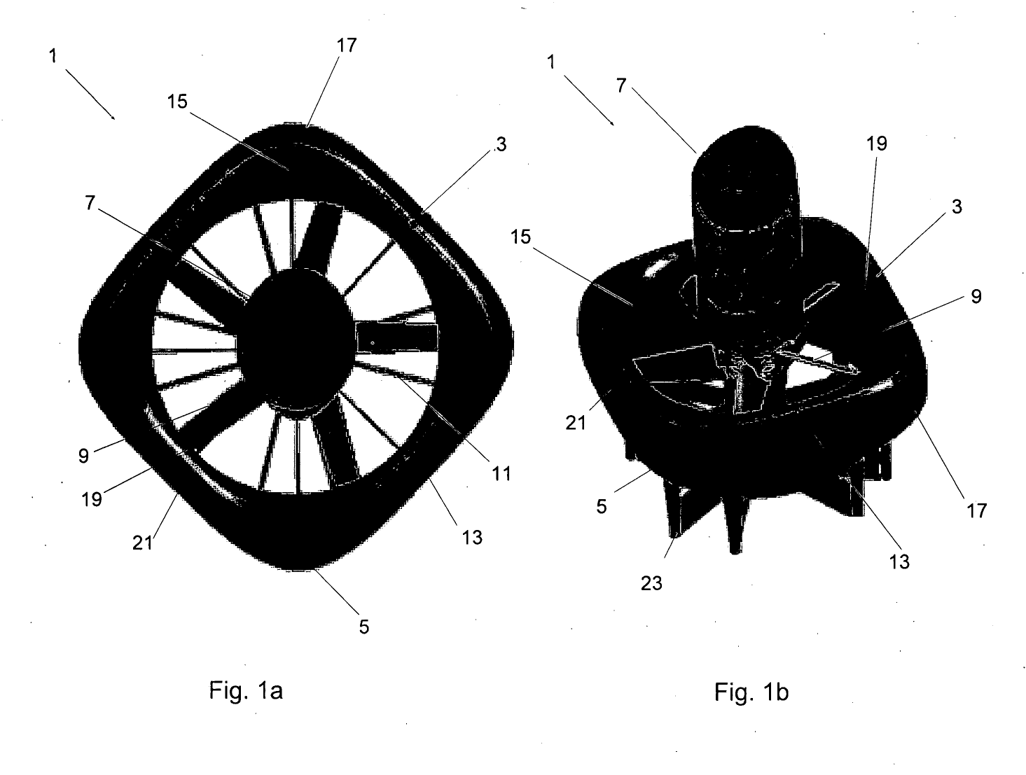

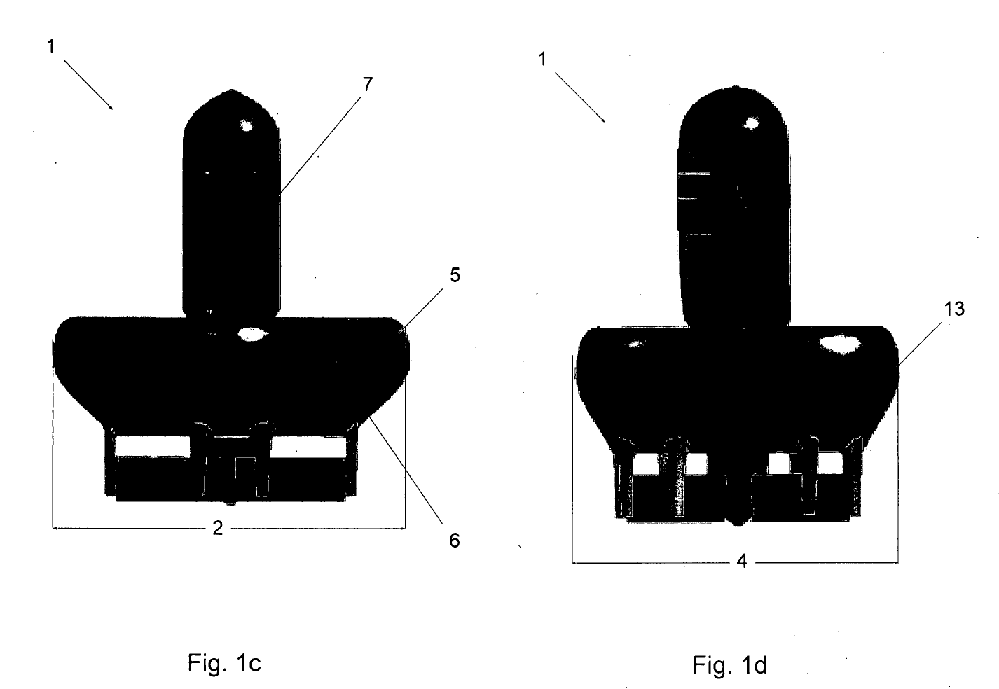

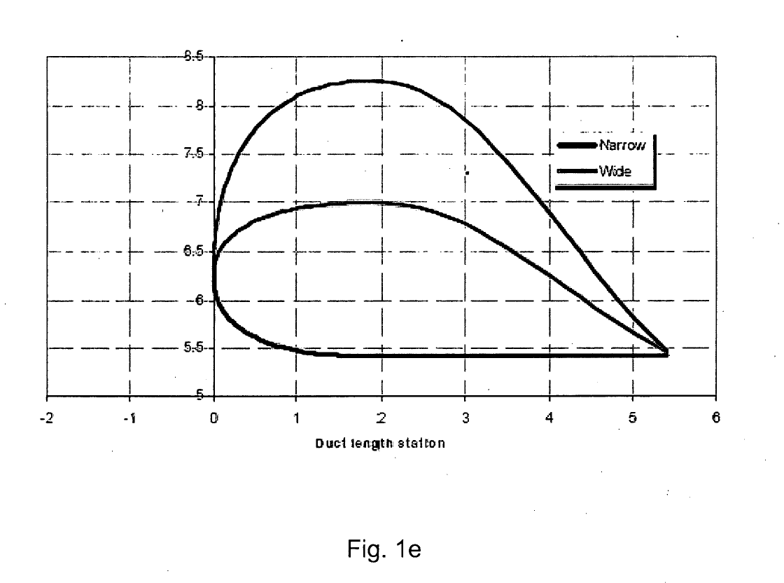

For instance, as shown in FIG. 1a, the cross-section of the duct 3 on a plane substantially perpendicular to the axis of rotation of the fan may have a substantially square shape. While the inner diameter of the duct 3 of the UAV 1 may remain circular, the outer profile of the duct may have a square shape. The additional interior space created between the inner and outer walls of the duct provides additional storage for equipment that may be carried on the UAV 1. The duct 3 shown in FIGS. 1a-d has a substantially square perimeter; however, the duct 3 may have other numbers of corners 5.

The UAV 1 of FIGS. 1a-1d has a fan with fan blades 9 driven by fan engine 7. The fan stators 11 may hold the duct 3 stationary in relation to the fan engine 7. The duct 3 has duct corners 5 and duct side walls 13. The duct side walls 13 may be thinner than the duct corners 5. The increased thickness of the duct corners 5 provides additional storage space for equipment to be stored on the UAV 1.

FIG. 1b shows a side view of the UAV 1. The landing gear 23 may be located at the base of the UAV 1, and may increase the stability of the UAV 1 during landing. As shown in FIG. 1b, the top surface of the duct 3 may have a substantially flat profile.

FIGS. 1c and 1d show side views of the UAV 1 indicating the difference between the length 2 from one corner 5 to the opposite corner 5, and the length 4 from one duct side wall 13 to the opposite duct side wall 13.

The length 2 of the UAV 1 shown in FIGS. 1a and 1d is approximately 27% greater than length 4. However, lengths 2, 4 may vary and length 2 may ideally be in the range of 10-40% greater than length 4. The difference between lengths 2, 4 affects the amount of cargo space located on the UAV 1 in a direction substantially perpendicular to the axis of rotation of the fan, and may affect overall vehicle performance. Therefore, the difference between lengths 2, 4 may be varied based on the storage requirements of the UAV 1 and the desired vehicle performance specifications.

The thickness of the duct 3 may taper down to the base 6. This tapered shape may provide improved vehicle performance, discussed further with respect to FIGS. 1e.

In laboratory testing, UAV 1 returned similar values for thrust, fuel efficiency, and stability to the values obtained for a traditional circular duct without duct corners 5. In some testing scenarios, UAV 1 actually showed improved thrust. This indicates that providing storage on the UAV 1 inside a square duct having corners 5 may provide storage space without significantly negatively affecting the airflow characteristics and fan efficiency of the UAV 1. For instance, in laboratory tests on a UAV 1 having dimensions of 14″ square and a weight of approximately 18.6 pounds, experimental data indicated that the thrust obtained by the fan was improved over a UAV having a traditional circular duct when both were in hover mode. In forward flight, the square UAV 1 performed slightly worse than the traditional circular duct.

The increased thrust may be attributed to the increased speed of the airflow as it flows over the thicker section of the duct corners 5. Because air may travel a longer distance over the lip of the duct 3 to the intake of the fan, the airspeed may increase and the pressure at the corners 5 may decrease. These factors may contribute to the improved overall thrust of the UAV 1.

Because the of the increased capacity in the corners 5 of the duct 3, the center of gravity of the UAV 1 may be shifted downwardly relative to the top surface of the duct 3. In order to maintain the stability of the UAV 1, this shift in the center of gravity may be compensated for by shifting the engine 7 upward along the axis or rotation, or by shifting another component of the UAV 1 upward in order to compensate for the shift caused by storing equipment in the duct corners 5.

FIG. 1e shows the cross-section of the duct 3 at the sidewall 13 and the corner 5. The increased thickness of the duct 3 at the corners 5 provides the additional storage space for electronics and other equipment on the UAV 1. As air passes over the thicker duct corner 5, the airspeed is increased compared to the air passing over the thinner duct side wall 13. This results in areas of relatively lower pressure and higher airspeed at the duct corners 5, contributing to improved airflow and thrust for the UAV 1. Additionally, the cross-section view of both the duct corner 5 and the duct sidewall 13 shows a cross-sectional shape similar to that of an airfoil. Because of the reduced air pressure over the curved portion of the duct 3 due to the increased air velocity, a lifting force is created in the direction perpendicular to the axis of rotation. In forward flight, the UAV 1 may benefit from the increased lift due to the increased thickness of the duct at the corners 5. For a UAV 1 in forward flight, a corner 5 located opposite the forward end of the UAV 1 may experience a lifting force at least partially in an upward direction. The corner 5 at the forward end of the UAV 1 may experience lifting force at least partially in a downward direction. However, because the UAV 1 in forward flight may experience air resistance in a direction opposite to the direction of translation because of the airflow that hits the duct corner outside wall 17 for the corner 5 on the forward end of the UAV 1, and to a lesser extent because of airflow that hits the duct corner inside wall 15 for the corner 5 opposite the forward end of the UAV 1, the lateral effect of the air resistance may reduce the negative lift caused by airflow over the corner 5 at the forward end of the UAV 1, and may increase the positive lift of the corner 5 at the end opposite the forward end of the UAV 1. Therefore, the net lifting force may be positive.

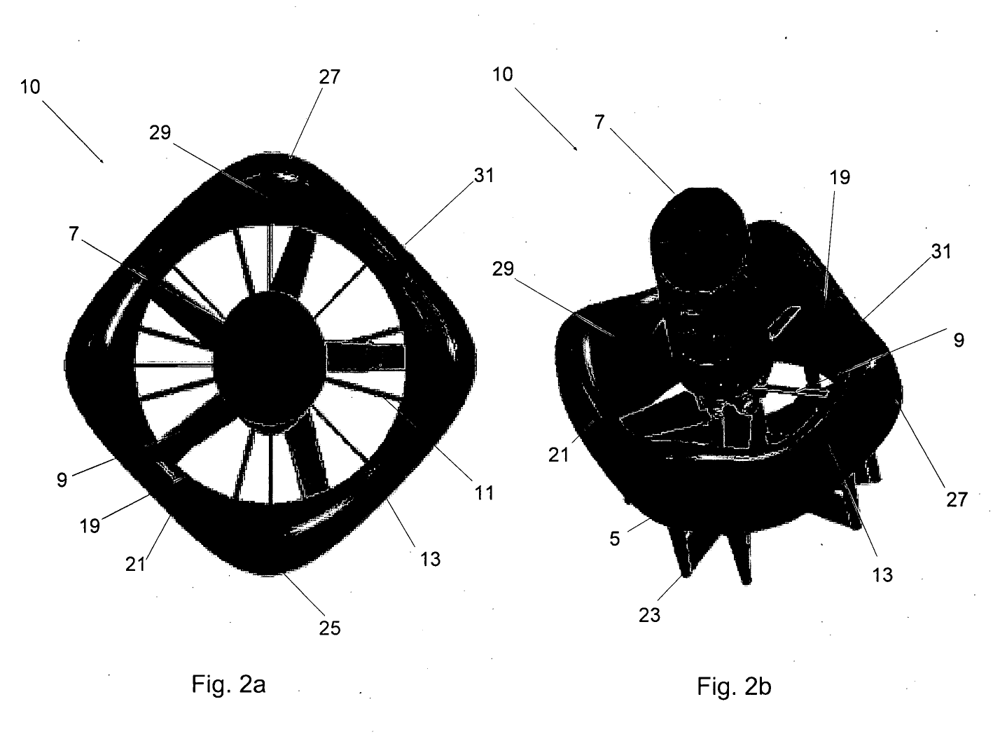

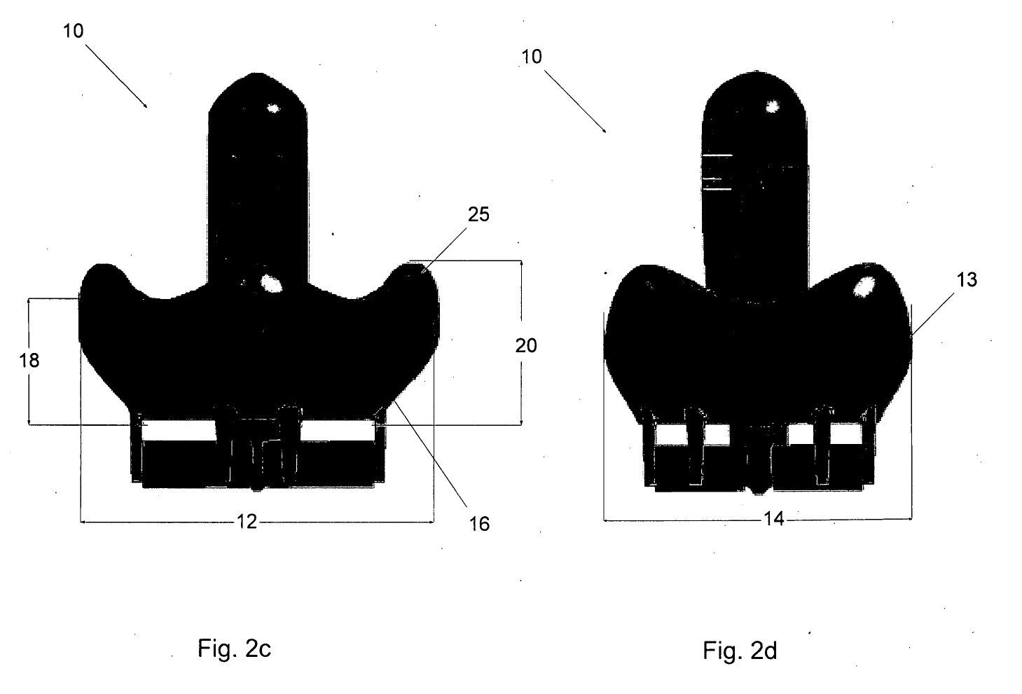

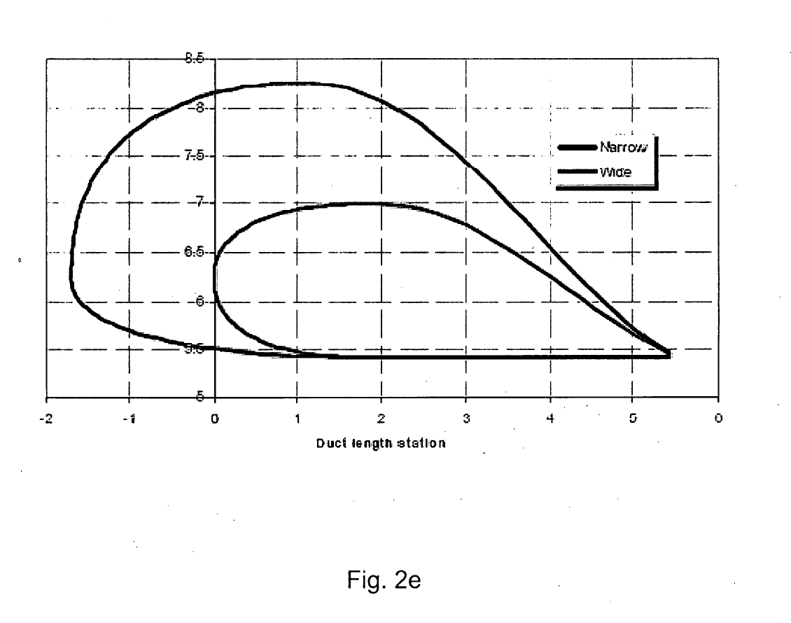

Referring to FIG. 2a, UAV 10 may have raised corners. The cross section of the duct 31 may be substantially square in a plane perpendicular to the axis of rotation of the fan. Alternatively, the corners 25 may extend further away from the axis of rotation, providing additional storage space in the direction of the plane perpendicular to the axis of rotation.

Because the inner diameter of the duct of the UAV 10 may remain circular and the outer perimeter of the duct 31 may have a substantially square shape, the space between the inner and outer walls of the duct 31 may provide storage space on the UAV 10. The raised corners may provide increased storage over the flat profiled duct 3 of UAV 1. Additionally, if the corners 25 are extended outwardly from the axis of rotation, additional storage space may be obtained at the corners 25 in the direction of the plane substantially perpendicular to the axis of rotation. The duct 31 shown in FIGS. 2a-d has a substantially square perimeter; however, the duct 31 may have other numbers of corners 25, and may have corners 25 extended outwardly from the axis of rotation.

The UAV 10 of FIGS. 2a-d has a fan with fan blades 9, a fan engine 7, stators 11, and landing gear 23 that function as described with respect to FIGS. 1a-d.

The duct 31 has duct corners 25 and duct side walls 13. The duct side walls 13 may be thinner than the duct corners 25. Additionally, as shown in FIG. 2b, the corners 25 may be raised in the direction of the axis of rotation. The additional height of the duct 31 in the direction of the axis of rotation provides additional storage for equipment on the UAV 10. The profile of the duct 31 on a plane parallel to the axis of rotation may have positive effects on thrust and fan efficiency, described further with respect to FIGS. 2c-d. The increased thickness of the duct corners 25 provides additional storage space for equipment to be stored on the UAV 10.

FIGS. 2c and 2d show a side view of the UAV 10 indicating the difference in width of the UAV 10 between the length 12 from one corner 25 to the opposite corner 25, and the length 14 from one duct side wall 13 to the opposite duct side wall 13.

The length 12, from one corner 25 to the opposite corner 25, of the UAV 10 shown in FIGS. 2a-d is approximately 25% greater than length 14, from one duct side wall 13 to the opposite duct side wall 13. However, the difference between lengths 12, 14 may vary and may ideally be in the range of 10-40%. The difference between lengths 12, 14 may affect the amount of cargo space located on the UAV 10 in a plane substantially perpendicular to the axis of rotation of the fan. Therefore, the difference between lengths 12, 14 may be varied based on the storage requirements of the UAV 10 and the desired fan performance specifications.

Length 18 of the UAV 10 shown in FIGS. 2a-d, between the low point of the duct side wall 13 and the base 16, is approximately 17% greater than length 20, between the top of the corner 25 and the base. The difference between lengths 18, 20 may vary and may be ideally in the range of 5-30%.

The difference between lengths 12, 14 may affect the amount of cargo space located on the UAV 10 in a direction substantially perpendicular to the axis of rotation of the fan. The difference between lengths 18, 20 may affect the amount of cargo space located on the UAV 10 in a direction substantially parallel to the axis of rotation of the fan. Additionally, the difference between lengths 12, 14 and the difference between lengths 18, 20 may affect the airflow, thrust, and efficiency of the fan, discussed further with respect to FIG. 2e. Therefore, the difference between lengths 12, 14 and the difference between lengths 18, 20 may be varied based on the storage requirements of the UAV 10 and the desired fan performance specifications.

In laboratory testing, UAV 10 showed improved values for thrust and fuel efficiency over values obtained for a traditional circular duct without duct corners 25. These experiments suggest that providing storage on the UAV 10 inside a square duct with raised corners 25 may enable cargo space to be provided on UAV 10 without significantly negatively affecting the airflow characteristics and fan efficiency of the UAV 10, and may possibly improve the overall performance of the UAV 10. For instance, in laboratory tests on a UAV 10 having dimensions of approximately 14″ square and a weight of approximately 18.6 pounds, experimental data indicated that the thrust obtained by UAV 10 improved by 8% in hover mode, and by 16% in forward flight.

The increased thrust may be attributed to the increased speed of the airflow as is flows over the thicker section of the duct corners 5. Because air may travel a longer distance over the raised corner of the duct 31 to the intake of the fan, the airspeed may increase and the pressure at the corners 25 may decrease. Also, because air has a shorter distance to travel over the low, thin duct side wall 13, the airspeed may be relatively slower and the air pressure may be relatively higher than the airspeed and the air pressure at the top of the corners 25. These factors may contribute to the improved overall thrust of the UAV 10.

Because the of the increased storage capacity in the corners 25 of the duct 31, the center of gravity of the UAV 10 may be, depending on the dimensions of the corners 25 and the difference of the lengths 12, 14 and the difference of the lengths 18,20, shifted upwardly relative to the top surface of the duct sidewalls 13. This may provide advantages, in that the overall stability of the UAV 10 may be improved because the tipping moment of the top-mounted engine 7 may be decreased when the UAV 10 is in forward flight. Additionally, the raised corners 25 may provide an ideal place to connect engine mounts for the engine 7. Because locating engine mounts for the engine 7 higher in relation to the base of the engine 7 may provide increased stability due to the decreased tipping moment of the engine 7 when compared to an engine having engine mounts located at the engine 7 base, the engine mounts may be reduced in size. Thus, the overall weight of the UAV 10 may be reduced. Additionally, as discussed with respect to FIG. 2e, the tapered shape of the duct may create lift on the UAV 1 in forward flight.

FIG. 2e shows the cross-section of the duct 3 at the sidewall 13 and the corner 25. The increased thickness of the duct 3 at the corners 25 provides additional storage space for electronics and other equipment on the UAV 10. As air passes over the thicker and taller duct corner 25, the airspeed is increased compared to the air passing over the thinner duct side wall 13. This results in areas of relatively lower pressure and higher airspeed at the duct corners 25, contributing to improved airflow and thrust for the UAV 10. The difference in airspeed and air pressure between the duct 31 at the corner 25 and the sidewall 13 for UAV 10 may be greater than the difference in airspeed and air pressure for the UAV 1 between the corner 5 and the sidewall 13 because of the greater distance the air must travel to reach the intake of the fan.

Additionally, the cross-section view of both the duct corner 25 and the duct sidewall 13 shows a cross-sectional shape similar to that of an airfoil, as described with respect to FIG. 1e. As described with respect to FIG. 1e, because of the reduced air pressure over the curved portion of the duct 31 due to the increased air velocity over the duct corners 25, a lifting force may created in the direction perpendicular to the axis of rotation. In forward flight, the UAV 10 may benefit from the increased lift due to the increased thickness and height of the duct at the corners 25. For the UAV 10 in forward flight, a corner 25 located opposite the forward end of the UAV 10 may experience a lifting force at least partially in an upward direction. The corner 25 at the forward end of the UAV 10 may experience lifting force at least partially in a downward direction. However, because the UAV 10 in forward flight may experience air resistance in a direction opposite to the direction of travel because of the airflow that hits the duct corner outside wall 17 for the corner 25 on the forward end of the UAV 10, and to a lesser extent because of airflow that hits the duct corner inside wall 15 for the corner 25 opposite the forward end of the UAV 10, the lateral force of the airflow may reduce the negative lift caused by airflow over the corner 25 at the forward end of the UAV 10, and may increase the positive lift of the corner 25 at the end opposite the forward end of the UAV 10. Therefore, the net lifting force may be positive.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

1. A duct for a ducted fan air vehicle comprising:
a fan comprising an axis of rotation; and
a duct comprising:
an inside duct wall having a substantially circular cross-section;
an outside duct wall cooperatively engaged with the inside duct wall to form an at least partially enclosed space; and
a plurality of enlarged areas of the at least partially enclosed space, wherein the plurality of enlarged areas extend outwardly in a direction perpendicular to the axis of rotation of the fan, and wherein portions of the outside duct wall defining the plurality of enlarged areas define surfaces of the duct that extend furthest from the axis of rotation of the fan in the direction perpendicular to the axis of rotation of the fan.

2. The ducted fan air vehicle of claim 1,
wherein the plurality of enlarged areas comprises four enlarged areas,
wherein the four enlarged areas are located on the outside duct wall, and
wherein the four enlarged areas form a substantially square perimeter shape of the outside duct wall.

3. The ducted fan air vehicle of claim 1, wherein the distance between the axis of rotation and the outside duct wall at the plurality of enlarged areas is between 10 and 40 percent larger than the distance between the axis of rotation and the inside duct wall.

4. (canceled)

5. The ducted fan air vehicle of claim 1, further comprising equipment in the plurality of enlarged areas, wherein an object fixably attached to the ducted fan air vehicle is shifted in a direction substantially parallel to the axis of rotation of the fan to at least partially compensate for the effect of weight of the equipment on the center of gravity of the ducted fan air vehicle.

6. The ducted fan air vehicle of claim 1, further comprising an engine,
wherein the engine drives the fan,
wherein the engine is fixed relative to the duct, and
wherein the engine is located along the axis of rotation of the fan to at least partially compensate for a change to a center of gravity of the ducted fan air vehicle caused by weight of equipment located in the plurality of enlarged areas.

7. The ducted fan air vehicle of claim 1:
wherein, at a top surface of the duct, the distance between the axis of rotation and the outside duct wall at the plurality of enlarged areas is 10-40% larger than the distance between the axis of rotation and the inside duct wall, and
wherein, at a bottom surface of the duct, the distance between the axis of rotation and the outside duct wall at the plurality of enlarged areas is approximately equal to the distance between the axis of rotation and the inside duct wall.

8. The ducted fan air vehicle of claim 7, wherein the inside duct wall and the outside duct wall collectively form an airfoil.

9. A duct for a ducted fan air vehicle comprising:
a fan comprising an axis of rotation; and
a duct comprising:
an inside duct wall having a substantially circular cross-section;
an outside duct wall cooperatively engaged with the inside duct wall to form an at least partially enclosed space; and
a plurality of enlarged areas of the at least partially enclosed space,
wherein the plurality of enlarged areas extend outwardly in a direction perpendicular to the axis of rotation of the fan, and wherein portions of the outside duct wall defining the plurality of enlarged areas define surfaces of the duct that extend furthest from the axis of rotation of the fan, and
wherein the plurality of enlarged areas extend upwardly in the direction of the axis of rotation of the fan.

10. The ducted fan air vehicle of claim 9, wherein the plurality of enlarged areas comprise four enlarged areas separated from one another by four side walls, wherein the four enlarged areas are located at 90 degree intervals along the perimeter of the duct, and a cross-sectional shape of the duct in a plane perpendicular to an axis of rotation of the fan is substantially square.

11. The ducted fan air vehicle of claim 9, wherein the distance between the axis of rotation and the outside duct wall at the plurality of enlarged areas is between 10 to 40 percent larger than the distance between the axis of rotation and the inside duct wall.

12. The ducted fan air vehicle of claim 10, wherein the distance between a top surface of an enlarged area of the four enlarged areas and a bottom surface of the duct is between 5 to 30 percent larger than the distance between a top surface of a duct side wall of the four side walls and the bottom surface of the duct.

13. The ducted fan air vehicle of claim 9, wherein each of the enlarged areas of the plurality of enlarged areas are each separated from an adjacent enlarged area by a duct side wall, and wherein the plurality of enlarged areas extend outwardly from a top surface of the duct side walls in a direction perpendicular to the axis of rotation of the fan.

14. The ducted fan air vehicle of claim 13, wherein the plurality of enlarged areas comprises four enlarged areas separated from one another by four side walls, wherein the four enlarged areas are located at 90 degree intervals along the perimeter of the duct, and wherein a cross-sectional shape of the duct in a plane perpendicular to an axis of rotation of the fan is substantially square.

15-16. (canceled)

17. The ducted fan air vehicle of claim 9, further comprising an engine:
wherein the engine drives the fan,
wherein the engine is fixed relative to the duct, and
wherein the engine is located along the axis of rotation of the fan to at least partially compensate for a change to a center of gravity of the ducted fan air vehicle caused by weight of equipment located in the plurality of enlarged areas.

18. The ducted fan air vehicle of claim 9:
wherein, at a top surface of the duct, the distance between the axis of rotation and the outside duct wall at the plurality of enlarged areas is between 10 to 40 percent larger than the distance between the axis of rotation and the inside duct wall, and
wherein, at a bottom surface of the duct, the distance between the axis of rotation and the duct outside wall at the plurality of enlarged areas is approximately equal to the distance between the axis of rotation and the inside duct wall.

19. The ducted fan air vehicle of claim 9, further comprising an engine:
wherein the engine drives the fan,
wherein the plurality of enlarged areas separate duct side walls, and
wherein the engine is fixed relative to the duct by engine supports extending between the engine and an area on the plurality of enlarged areas located above a top surface of the duct side walls.

20. A ducted fan air vehicle comprising:
a fan comprising fan blades,
an engine configured to drive the fan blades,
a plurality of stators downstream of the fan blades, and
a duct comprising:
an inside duct wall having a substantially circular cross-section;
an outside duct wall, wherein the inside duct wall and the outside duct wall cooperatively form an at least partially enclosed space; and
four enlarged areas separated from one another by four side walls,
wherein the four enlarged areas are located at 90 degree intervals along the a perimeter of the duct,
wherein a cross-sectional shape of the duct in a plane perpendicular to an axis of rotation of the fan is substantially square,
wherein the four enlarged areas extend outwardly in a direction perpendicular to an axis of rotation of the fan,
wherein the four enlarged areas extend upwardly in the direction of the axis of rotation of the fan,
wherein the distance between the axis of rotation and the outside duct wall at the four enlarged areas is between 10 to 40 percent larger than the distance between the axis of rotation and the inside duct wall, and
wherein the distance between a top surface of one of the enlarged areas and a bottom surface of the duct is between 5 to 30 percent larger than the distance between a top surface of one of the side walls and the bottom surface of the duct.

21. The ducted fan air vehicle of claim 1, wherein the plurality of enlarged areas are configured such that air passing over the duct at the plurality of enlarged areas creates a greater lifting force in the direction perpendicular to the axis of rotation of the fan relative to other areas of the duct.

22. The ducted fan air vehicle of claim 9, wherein, at the plurality of enlarged areas, a surface of the duct on an intake side of the fan extends upwardly away from the fan in the direction of the axis of rotation of the fan.

23. The ducted fan air vehicle of claim 20, wherein, at the four enlarged areas, a surface of the duct on an intake side of the fan extends upwardly away from the fan in the direction of the axis of rotation of the fan.
